(19) United States
(12) Patent Application Publication
(10) Pub. No.: US 2025/0124723 A1
(43) Pub. Date: Apr. 17, 2025

(54) POINT CLOUD PROCESSING SYSTEM, POINT CLOUD PROCESSING APPARATUS, POINT CLOUD PROCESSING METHOD

(71) Applicant: NEC Corporation, Tokyo (JP)

(72) Inventor: Junichi Abe, Tokyo (JP)

(73) Assignee: NEC Corporation, Tokyo (JP)

(21) Appl. No.: 18/904,324

(22) Filed: Oct. 2, 2024

(30) Foreign Application Priority Data
Oct. 12, 2023 (JP) 2023-176799

(51) Int. Cl. G06V 20/56; G06T 7/33

(52) U.S. Cl. CPC G06V 20/588; G06T 7/337; G06T 2207/10028; G06T 2207/30256

(57) ABSTRACT

Provided is a point cloud processing system including: a sensing information acquisition means for acquiring sensing information including a sensing point cloud generated by a sensing means, which is mounted on a moving body traveling on any one of a plurality of travel tracks extending in parallel to one another, for sensing an area ahead in a heading direction of the moving body, and track identification information identifying a travel track on which the moving body travels while performing sensing; and a first registration means for registering the sensing point cloud with respect to a travel track point cloud associated with the travel track on which the moving body travels while performing sensing, among a travel environment point cloud being a known point cloud of a travel environment including the plurality of travel tracks.

### INCORPORATION BY REFERENCE

This application is based upon and claims the benefit of priority from Japanese patent application No. 2023-176799, filed on Oct. 12, 2023, the disclosure of which is incorporated herein in its entirety by reference.

### TECHNICAL FIELD

The present disclosure relates to a point cloud processing system, a point cloud processing apparatus, a point cloud processing method, and a non-transitory computer readable medium.

### BACKGROUND ART

Japanese Unexamined Patent Application Publication No. 2019-197453 discloses a server apparatus including: a collection unit configured to collect, in association with identification information, route information indicating a route traveled by a vehicle equipped with a sensor and sensor information collected by the sensor during traveling on the route; a generation unit configured to generate map information for a vehicle having an autonomous traveling function to autonomously travel the route indicated by the route information, based on the route information and the sensor information being collected by the collection unit; and a provision unit configured to provide the map information generated by the generation unit for an object specified by the identification information.

### SUMMARY

In order to achieve automatic driving of an automobile or a train, a three-dimensional point cloud in a moving space in which the automobile or the train moves is required. Simultaneous localization and mapping (SLAM) is known as a technique for generating a three-dimensional point cloud. Typically, the SLAM is a technique for estimating a self-position of a light detection and ranging (LiDAR) point cloud, which is output from a LiDAR apparatus, by performing registration of the LiDAR point cloud with respect to a known three-dimensional point cloud, and reconstructing the three-dimensional point cloud, based on a self-position estimation result and the LiDAR point cloud. Iterative closest point (ICP) and normal distributions transform (NDT) are known as a technique for registering a LiDAR point cloud with respect to a known three-dimensional point cloud. These registration techniques have a characteristic that success or failure of the registration strongly depends on accuracy of an initial position of the LiDAR point cloud with respect to the known three-dimensional point cloud when the LiDAR point cloud is registered with respect to the known three-dimensional point cloud. Specifically, in a case where accuracy of the initial position is poor, convergence of a registration operation for registering the LiDAR point cloud with respect to the known three-dimensional point cloud tends to be poor and operation duration tends to be long, and in some cases, the registration operation may converge into a wrong local optimal solution.

An example object of the present disclosure is to provide a technique for registering a sensing point cloud with respect to a travel environment point cloud in a short time.

In a first example aspect, a point cloud processing system includes:
a sensing information acquisition means for acquiring sensing information including a sensing point cloud generated by a sensing means, which is mounted on a moving body traveling on any one of a plurality of travel tracks extending in parallel to one another, for sensing an area ahead in a heading direction of the moving body, and track identification information identifying a travel track on which the moving body travels while performing sensing; and
a first registration means for registering the sensing point cloud with respect to a travel track point cloud associated with the travel track on which the moving body travels while performing sensing, among a travel environment point cloud being a known point cloud of a travel environment including the plurality of travel tracks.

In a second example aspect, a point cloud processing apparatus includes:
a sensing information acquisition means for acquiring sensing information including a sensing point cloud generated by a sensing means, which is mounted on a moving body traveling on any one of a plurality of travel tracks extending in parallel to one another, for sensing an area ahead in a heading direction of the moving body, and track identification information identifying a travel track on which the moving body travels while performing sensing; and
a first registration means for registering the sensing point cloud with respect to a travel track point cloud associated with the travel track on which the moving body travels while performing sensing, among a travel environment point cloud being a known point cloud of a travel environment including the plurality of travel tracks.

In a third example aspect, a point cloud processing method includes:
acquiring sensing information including a sensing point cloud generated by a sensing means, which is mounted on a moving body traveling on any one of a plurality of travel tracks extending in parallel to one another, for sensing an area ahead in a heading direction of the moving body, and track identification information identifying a travel track on which the moving body travels while performing sensing; and
registering the sensing point cloud with respect to a travel track point cloud associated with the travel track on which the moving body travels while performing sensing, among a travel environment point cloud being a known point cloud of a travel environment including the plurality of travel tracks.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram of a point cloud processing system;

FIG. 2 is a plan view of a railway track environment;

FIG. 3 is a block diagram of a train;

FIG. 4 is a block diagram of an information processing apparatus;

FIG. 5 is a plan view illustrating a relationship between a travel environment point cloud and a travel track point cloud;

FIG. 6 is a data structure of a registration result storage unit;

FIG. 7 is a control flow of the information processing apparatus;

FIG. 8 is a diagram illustrating a case where a processing circuit included in the information processing apparatus is constituted of a processor and a memory; and

FIG. 9 is a diagram illustrating a case where the processing circuit included in the information processing apparatus is constituted of dedicated hardware.

### EXAMPLE EMBODIMENT

### (Outline of the Present Disclosure)

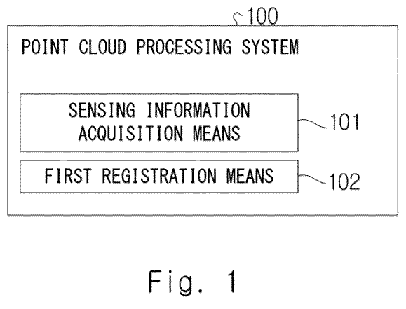

Hereinafter, an outline of the present disclosure is described. FIG. 1 is a block diagram of a point cloud processing system 100. As illustrated in FIG. 1, the point cloud processing system 100 includes a sensing information acquisition means 101 and a first registration means 102.

The sensing information acquisition means 101 acquires sensing information including a sensing point cloud generated by a sensing means, which is mounted on a moving body traveling on any one of a plurality of travel tracks extending in parallel to each other, by sensing an area ahead in a heading direction of the moving body, and track identification information identifying a travel track on which the moving body traveled while performing sensing.

The first registration means 102 registers the sensing point cloud with respect to a travel track point cloud associated with the travel track on which the moving body traveled while performing sensing, among a travel environment point cloud that is a known point cloud of a travel environment including the plurality of travel tracks.

According to the above-described configuration, it is possible to register the sensing point cloud to the travel environment point cloud in a short time.

### First Example Embodiment

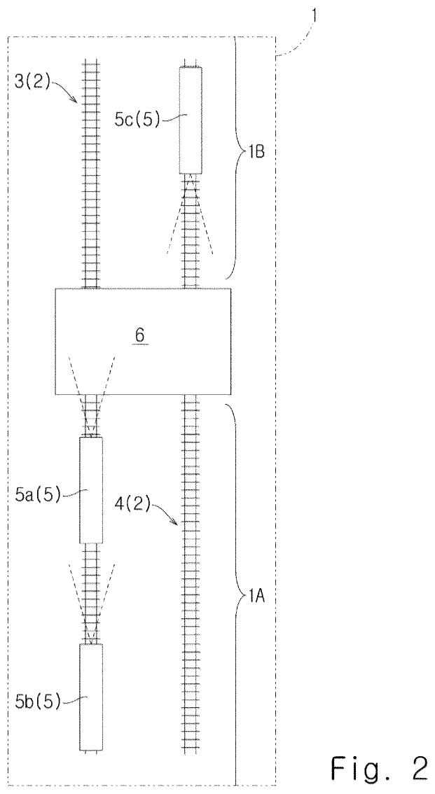

Next, a first example embodiment of the present disclosure is described. FIG. 2 is a plan view of a railway track environment 1. The railway track environment 1 includes a plurality of railway tracks 2 extending parallel to each other. The railway track environment 1 is one specific example of a travel environment. The railway track 2 is one specific example of a travel track. In the present example embodiment, the railway track environment 1 includes two railway tracks 2 extending parallel to each other. Alternatively, however, the railway track environment 1 may include three or more railway tracks 2 extending parallel to each other.

As illustrated in FIG. 2, the two railway tracks 2 include a first railway track 3 and a second railway track 4. Several trains 5 are traveling along each railway track 2. FIG. 2 illustrates a train 5a and a train 5b as the trains 5 traveling along the first railway track 3. Similarly, a train 5c is illustrated as the train 5 traveling along the second railway track 4. The heading direction of the train 5a and the train 5b traveling along the first railway track 3 and the heading direction of the train 5c traveling along the second railway track 4 are opposite to each other. The train 5a travels ahead of the train 5b.

An information processing apparatus 6 is arranged in the railway track environment 1. The information processing apparatus 6 is an apparatus that assists the operation of the plurality of trains 5 by transmitting and receiving various data to and from the plurality of trains 5. Hereinafter, for convenience of explanation, the railway track environment 1 is divided into a railway track section 1A and a railway track section 1B along the longitudinal direction of the railway track environment 1. The railway track section 1A and the railway track section 1B are defined in such a way that the information processing apparatus 6 is arranged between the railway track section 1A and the railway track section 1B in the longitudinal direction of the railway track environment 1.

Further, at a certain point in time, it is assumed that the train 5a and the train 5b are traveling in the railway track section 1A toward the information processing apparatus 6 while sensing an area ahead in the heading direction, and the train 5c is traveling in the railway track section 1B toward the information processing apparatus 6 while sensing an area ahead in the heading direction. In addition, the train 5a, the train 5b, and the train 5c may temporarily stop in the information processing apparatus 6 or may pass without stopping. It is assumed that the train 5a, the train 5b, and the train 5c arrive at the information processing apparatus 6 in this order.

With the above configuration, the train 5a, the train 5b, and the train 5c transmit a sensing result acquired by sensing an area ahead in the heading direction to the information processing apparatus 6, and receive operation assistance information from the information processing apparatus 6. As a result, stable operation of the train 5a, the train 5b, and the train 5c is achieved.

### <Train 5>

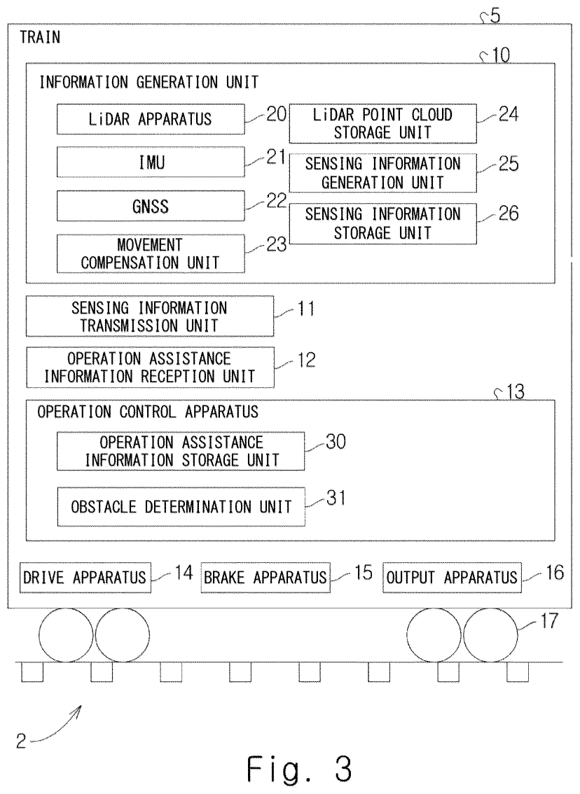

Next, the train 5 is described in detail. FIG. 3 is a block diagram of the train 5. The configurations of the train 5a, the train 5b, and the train 5c are the same.

As illustrated in FIG. 3, the train 5 includes an information generation unit 10, a sensing information transmission unit 11, an operation assistance information reception unit 12, an operation control apparatus 13, a drive apparatus 14, a brake apparatus 15, and an output apparatus 16.

The drive apparatus 14 is constituted of a motor and a motor driver. The drive apparatus 14 drives wheels 17 in accordance with a control signal from the operation control apparatus 13.

The brake apparatus 15 is constituted of a brake and a hydraulic circuit. The brake apparatus 15 brakes the wheels 17 in accordance with a control signal from the operation control apparatus 13.

The output apparatus 16 is typically constituted of a display capable of outputting a screen or a speaker capable of outputting sound.

The information generation unit 10 includes a LiDAR apparatus 20, an IMU 21, a GNSS 22, a movement compensation unit 23, a LiDAR point cloud storage unit 24, a sensing information generation unit 25, and a sensing information storage unit 26.

The LiDAR apparatus 20 is one specific example of a sensing means for generating a three-dimensional point cloud by sensing an area ahead in the heading direction of the train 5. The LiDAR apparatus 20 according to the present example embodiment is a direct time of flight (ToF) type. That is, the LiDAR apparatus 20 generates a three-dimensional point cloud of an area ahead in the heading direction of the train 5 by emitting a laser beam forward in the heading direction of the train 5 and measuring a time required for receiving a reflected light thereof. However, instead of this, the LiDAR apparatus 20 may be a frequency modulated continuous wave (FMCW) type that generates the three-dimensional point cloud described above, based on a frequency difference between the laser beam emitted forward in the heading direction of the train 5 and the reflected light thereof. Further, the LiDAR apparatus 20 may be an indirect ToF type that generates the three-dimensional point cloud escribed above, based on a phase difference between the laser beam emitted forward in the heading direction of the train 5 and the reflected light thereof. The LiDAR apparatus 20 accumulates the generated three-dimensional point cloud (hereinafter, also simply referred to as a point cloud) in the LiDAR point cloud storage unit 24 as a LiDAR point cloud.

Note that the sensing means is not limited to the LiDAR apparatus 20. As the sensing means, any apparatus can be adopted as long as it can perform sensing of an area ahead in the heading direction of the train 5. For example, the sensing means may be configured to generate a three-dimensional point cloud by a radio detection and ranging (Radar) apparatus, an ultrasonic sensor, a stereo-camera, or combinations thereof. Further, the sensing means may be configured to generate a three-dimensional point cloud by structure from motion (SfM) from a plurality of two-dimensional images acquired by imaging an area ahead in the heading direction of the train 5.

The IMU 21 is configured to detect triaxial acceleration and triaxial angular velocity of the train 5.

The GNSS 22 is configured to detect the position of the train 5.

The movement compensation unit 23 performs movement compensation of the LiDAR point cloud stored in the LiDAR point cloud storage unit 24, based on the detection result of the IMU 21.

The sensing information generation unit 25 generates sensing information including the LiDAR point cloud and railway track identification information. The railway track identification information is one specific example of the track identification information. The railway track identification information is information identifying the railway track 2 on which the train 5 traveled while performing sensing. In the example of FIG. 2, the railway track identification information of the sensing information generated by the sensing information generation units 25 of the train 5a and the train 5b is information indicating the first railway track 3. Similarly, the railway track identification information of the sensing information generated by the sensing information generation unit 25 of the train 5c is information indicating the second railway track 4.

As the railway track identification information, various forms are conceivable as long as the information identifies the railway track 2 on which the train 5 traveled while performing sensing. For example, the railway track identification information may be information indicating the position of the train 5, acquired based on the detection result of the GNSS 22. In such a case, the railway track identification information may be individually assigned to each of a plurality of ranging points constituting the LiDAR point cloud, or may be stored as header information of the LiDAR point cloud. Herein, the means for detecting the position of the train 5 is not limited to the GNSS 22. For example, the position of the train 5 may be estimated by a SLAM, a magnetic marker, a gyro, the IMU 21, or combinations thereof.

The sensing information generation unit 25 stores the generated sensing information in the sensing information storage unit 26.

The sensing information transmission unit 11 transmits the sensing information stored in the sensing information storage unit 26 to the information processing apparatus 6 through wired communication or wireless communication. The data amount of the sensing information is typically set to about several gigabytes to several hundred gigabytes.

The operation assistance information reception unit 12 receives the operation assistance information from the information processing apparatus 6 through wired communication or wireless communication.

The operation control apparatus 13 includes an operation assistance information storage unit 30 and an obstacle determination unit 31.

The operation assistance information storage unit 30 stores the operation assistance information received by the operation assistance information reception unit 12.

The obstacle determination unit 31 determines the presence or absence of an obstacle in an area ahead in the heading direction of the train 5, based on the operation assistance information stored in the operation assistance information storage unit 30. When an obstacle in the area ahead in the heading direction of the train 5 is detected, the obstacle determination unit 31 outputs an obstacle warning screen to the output apparatus 16 and outputs a control signal for causing the brake apparatus 15 to stop the train 5.

### <Information Processing Apparatus 6>

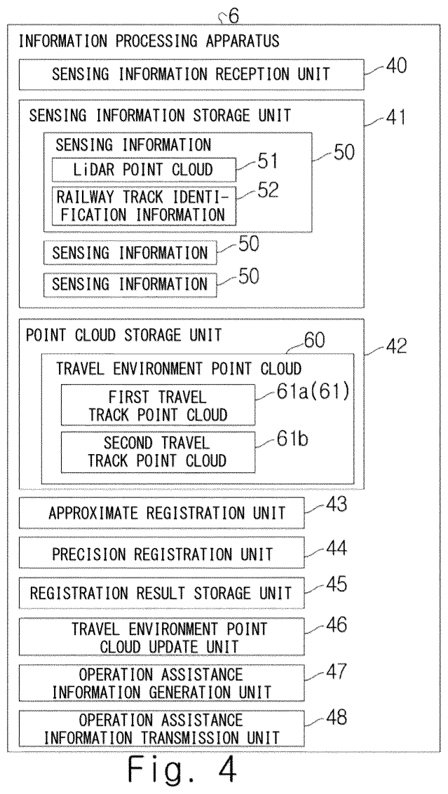

Next, the information processing apparatus 6 is described in detail. FIG. 4 is a block diagram of the information processing apparatus 6. In the present example embodiment, the information processing apparatus 6 is achieved by a single apparatus. However, instead of this, the information processing apparatus 6 may be achieved by distributed processing performed by a plurality of apparatuses. For example, a server remote from the information processing apparatus 6 may share a part of the functions of the information processing apparatus 6.

The information processing apparatus 6 includes a sensing information reception unit 40, a sensing information storage unit 41, a point cloud storage unit 42, an approximate registration unit 43, a precision registration unit 44, a registration result storage unit 45, a travel environment point cloud update unit 46, an operation assistance information generation unit 47, and an operation assistance information transmission unit 48.

The sensing information reception unit 40 receives sensing information 50 from the train 5 that has reached the information processing apparatus 6. The sensing information reception unit 40 stores the received sensing information 50 in the sensing information storage unit 41. As described above, the sensing information 50 is constituted of a LiDAR point cloud 51 and railway track identification information 52. Each time the train 5 reaches the information processing apparatus 6, the sensing information reception unit 40 receives the sensing information 50 from the train 5 and accumulates the received information in the sensing information storage unit 41. Therefore, a plurality of pieces of sensing information 50 are accumulated in the sensing information storage unit 41.

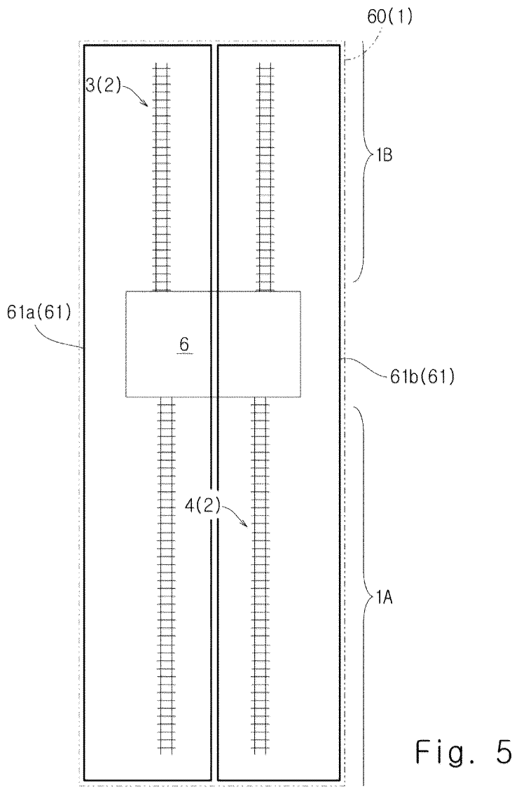

The point cloud storage unit 42 stores a travel environment point cloud 60. The travel environment point cloud 60 is a point cloud of the railway track environment 1 illustrated in FIG. 2. The travel environment point cloud 60 includes a point cloud associated with the first railway track 3, a point cloud associated with the second railway track 4, and a point cloud associated with a tree or a building around the first railway track 3 or the second railway track 4, a person, or an animal. As illustrated in FIGS. 4 and 5, the point cloud storage unit 42 classifies the travel environment point cloud 60 into a plurality of travel track point clouds 61 and stores the classified point clouds. The plurality of travel track point clouds 61 includes a first travel track point cloud 61a and a second travel track point cloud 61b. The travel environment point cloud 60 is constituted of the first travel track point cloud 61a and the second travel track point cloud 61b. The first travel track point cloud 61a is a point cloud associated with the first railway track 3 and the periphery of the first railway track 3. The second travel track point cloud 61b is a point cloud associated with the second railway track 4 and the periphery of the second railway track 4.

Returning to FIG. 4, the approximate registration unit 43 is one specific example of the first registration means. The approximate registration unit 43 performs approximate registration of the LiDAR point cloud 51 with respect to the travel environment point cloud 60. Specifically, the approximate registration unit 43 registers the LiDAR point cloud 51 with respect to a travel track point cloud 61 associated with the LiDAR point cloud 51 among the plurality of travel track point clouds 61 constituting the travel environment point cloud 60. Typically, the approximate registration unit 43 performs the above-described approximate registration by using iterative closest point (ICP) and normal distributions transform (NDT). The technical significance of the approximate registration unit 43 registering the LiDAR point cloud 51 with respect to a part of the travel environment point cloud 60 instead of registering the LiDAR point cloud 51 with respect to the entire travel environment point cloud 60 is as follows. That is, the target point cloud for registering the LiDAR point cloud 51 is narrowed down to a point cloud being closely related to the LiDAR point cloud 51. Accordingly, since the convergence of the registration algorithm is improved, the processing time required for registering the LiDAR point cloud 51 with respect to the travel environment point cloud 60 is shortened. In particular, in a case such as a railway, where the movement dimension of the train 5 can be regarded as being one-dimensional, the above-described registration can be completed by one-dimensional parameter adjustment by narrowing down the target point cloud as described above. Additionally, in this sense, by narrowing down the target point cloud for registering the LiDAR point cloud 51 as described above, it is possible to greatly reduce the processing time required for registering the LiDAR point cloud 51.

As described above, the approximate registration unit 43 registers the LiDAR point cloud 51 with respect to the travel track point cloud 61 associated with the LiDAR point cloud 51, among the plurality of travel track point clouds 61 constituting the travel environment point cloud 60. Herein, the approximate registration unit 43 is able to identify the travel track point cloud 61 associated with the LiDAR point cloud 51 among the plurality of travel track point clouds 61 by referring to the railway track identification information 52 associated with the LiDAR point cloud 51.

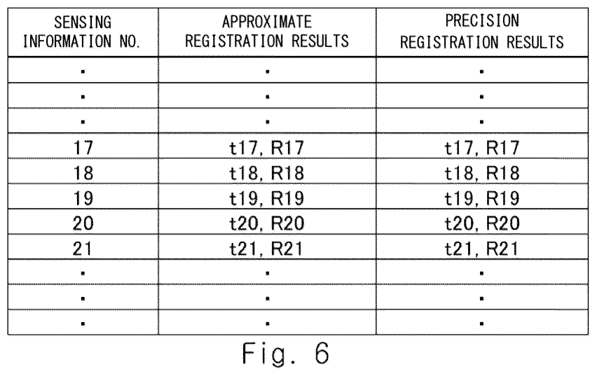

The approximate registration unit 43 stores an approximate registration result, which is a result of the approximate registration described above, in the registration result storage unit 45. FIG. 6 illustrates the data structure of the registration result storage unit 45. As illustrated in FIG. 6, the registration result storage unit 45 stores the sensing information 50 and the approximate registration result associated with the relevant sensing information 50 in association with each other. The approximate registration result is composed of relative translational data t and rotational data R of the coordinate axes of the LiDAR point cloud 51 with respect to the coordinate axes of the travel environment point cloud 60.

The precision registration unit 44 is one specific example of the second registration means. The precision registration unit 44 performs the precision registration of the LiDAR point cloud 51 with respect to the travel environment point cloud 60 by using the approximate registration result as the initial condition. Specifically, the precision registration unit 44 performs the precision registration of the LiDAR point cloud 51 with respect to the travel environment point cloud 60 constituted of a plurality of travel track point clouds 61 by using the approximate registration result as an initial condition. Typically, the precision registration unit 44 performs the above-described precision registration by using iterative closest point (ICP) and normal distributions transform (NDT). The technical significance of the precision registration unit 44 registering the LiDAR point cloud 51 with respect to the entire travel environment point cloud 60 instead of registering the LiDAR point cloud 51 with respect to a part of the travel environment point cloud 60 is as follows. That is, for example, the LiDAR point cloud 51 generated by the train 5a traveling on the first railway track 3 may include not only a point cloud associated with the first railway track 3 but also a point cloud associated with the second railway track 4 or a tree or a building around the second railway track 4. Therefore, by registering also with respect to the point cloud associated with the second railway track 4 and the trees and buildings around the second railway track 4 in addition to registering the LiDAR point cloud 51 with respect to the point cloud associated with the first railway track 3, there is an advantage that the registration can be performed with higher accuracy. However, when the LiDAR point cloud 51 is registered to the travel environment point cloud 60, depending on the accuracy of the initial position of the LiDAR point cloud 51 with respect to the travel environment point cloud 60, there is a problem in that the registration calculation does not converge or the registration calculation converges to an incorrect local optimal solution. Therefore, in the present example embodiment, the precision registration unit 44 performs the precision registration of the LiDAR point cloud 51 with respect to the travel environment point cloud 60 by using the approximate registration result as an initial condition, as described above. Specifically, the precision registration unit 44 sets the initial position of the LiDAR point cloud 51 in the coordinate system of the travel environment point cloud 60, based on the approximate registration result, and then performs the precision registration of the LiDAR point cloud 51 with respect to the travel environment point cloud 60. Thus, the precision registration by the precision registration unit 44 may be performed with good convergence.

The precision registration unit 44 stores a precision registration result, which is a result of the precision registration described above, in the registration result storage unit 45. As illustrated in FIG. 6, the registration result storage unit 45 stores the sensing information 50, the approximate registration result associated with the relevant sensing information 50, and the precision registration result associated with the relevant sensing information 50 in association with one another. The precision registration result is composed of relative translational data t and rotational data R of the coordinate axes of the LiDAR point cloud 51 with respect to the coordinate axes of the travel environment point cloud 60, similarly to the approximate registration result.

The travel environment point cloud update unit 46 updates the travel environment point cloud 60, based on the precision registration result and the LiDAR point cloud 51. The travel environment point cloud update unit 46 constructs a new travel environment point cloud 60 by joining a plurality of sets of LiDAR point clouds 51 to one another, based on the precision registration result, and updates the travel environment point cloud 60 by replacing the travel environment point cloud 60 stored in the point cloud storage unit 42 with the newly constructed travel environment point cloud 60.

The operation assistance information generation unit 47 generates operation assistance information, based on the travel environment point cloud 60 updated by the travel environment point cloud update unit 46. As the operation assistance information, various forms are conceivable. The operation assistance information may be, for example, the updated travel environment point cloud 60 itself, information acquired by removing noise point cloud from the updated travel environment point cloud 60, information acquired by resampling the updated travel environment point cloud 60, or information acquired by compressing data of the updated travel environment point cloud 60. Alternatively, the operation assistance information may be information acquired by converting the updated travel environment point cloud 60 into voxel data, information acquired by converting the updated travel environment point cloud 60 into polygon data, or information acquired by semantically segmenting the updated travel environment point cloud 60. The operation assistance information may include information relating to a terrain of the railway track environment 1, a natural object existing in the railway track environment 1, an obstacle existing on the railway track 2 of the railway track environment 1, and an intruder to the railway track environment 1. The operation assistance information may include physical information relating to a size and a moving speed of an obstacle existing on the railway track 2 of the railway track environment 1 or an intruder to the railway track environment 1.

The operation assistance information transmission unit 48 transmits the operation assistance information to the train 5 that has reached the information processing apparatus 6. Specifically, the operation assistance information transmission unit 48 transmits, to the train 5 that has reached the information processing apparatus 6, the operation assistance information relating to a section in which the train 5 is to travel. For example, when the train 5a reaches the information processing apparatus 6, the operation assistance information transmission unit 48 transmits operation assistance information relating to the railway track section 1B to the train 5a. For example, when the train 5c reaches the information processing apparatus 6, the operation assistance information transmission unit 48 transmits operation assistance information relating to the railway track section 1A to the train 5c.

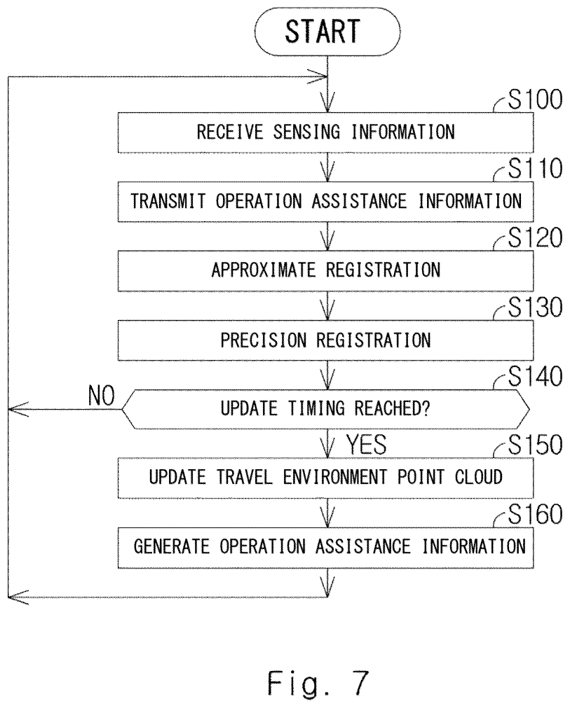

Next, a control flow of the information processing apparatus 6 is described with reference to FIG. 7.

First, when the train 5a reaches the information processing apparatus 6, the sensing information reception unit 40 receives the sensing information 50 relating to the railway track section 1A from the train 5a (S100), and the operation assistance information transmission unit 48 transmits the operation assistance information relating to the railway track section 1B to the train 5a (S110). Next, the approximate registration unit 43 performs the approximate registration of the LiDAR point cloud 51 with respect to the first travel track point cloud 61a of the travel environment point cloud 60 (S120). Next, the precision registration unit 44 performs the precision registration of the LiDAR point cloud 51 with respect to the travel environment point cloud 60 by using the approximate registration result acquired in step S120 as an initial condition (S130). Next, the travel environment point cloud update unit 46 determines whether the update timing has been reached (S140). The update timing is set from various viewpoints. For example, the update timing may be a timing at which the information processing apparatus 6 has received the sensing information 50 from the plurality of trains 5 a predetermined number of times. Further, the update timing may be a predetermined time in a midnight time zone in which the vehicle is not operated. Further, the update timing may be a timing after a predetermined time has elapsed after the information processing apparatus 6 received the sensing information 50 from the train 5. That is, the update timing may be generated each time the information processing apparatus 6 receives the sensing information 50 from the train 5.

When NO in step S140, the travel environment point cloud update unit 46 returns the process to step S100. By repeating the processes from step S100 to step S140, the sensing information reception unit 40 may receive the sensing information 50 from each of the train 5a, the train 5b, and the train 5c (S100), and the plurality of sensing information 50 may be accumulated in the sensing information storage unit 26.

When YES in step S140, the travel environment point cloud update unit 46 updates the travel environment point cloud 60, based on the one or more pieces of sensing information 50 accumulated in the sensing information storage unit 41 and the precision registration result stored in the registration result storage unit 45 (S150). Then, the operation assistance information generation unit 47 generates the operation assistance information, based on the updated travel environment point cloud 60 (S160), and returns the process to step S100.

The first example embodiment of the present disclosure has been described above. The first example embodiment has the following features.

The information processing apparatus 6 (point cloud processing system) includes the sensing information reception unit 40 and the approximate registration unit 43. The sensing information reception unit 40 acquires sensing information 50 including the LiDAR point cloud 51 (sensing point cloud) generated by the LiDAR apparatus 20 (sensing means), which is mounted on the train 5 (moving body) traveling on any one of the plurality of railway tracks 2 (travel tracks) extending parallel to each other, by sensing the area ahead in the heading direction of the train 5, and the railway track identification information 52 (track identification information) identifying the railway track 2 on which the train 5 traveled while performing sensing. The approximate registration unit 43 registers the LiDAR point cloud with respect to the travel track point cloud 61 associated with the railway track 2 on which the train 5 traveled while performing sensing, among the travel environment point cloud 60 that is a known point cloud of the railway track environment 1 (travel environment) including the plurality of railway tracks 2. According to the above-described configuration, the LiDAR point cloud 51 can be registered with respect to the travel environment point cloud 60 in a short time.

The information processing apparatus 6 further includes the precision registration unit 44 (second registration means) configured to register the LiDAR point cloud with respect to the travel environment point cloud 60 by using the approximate registration result (registration result) acquired by registering the LiDAR point cloud 51 with respect to the travel track point cloud 61 as an initial condition. According to the above-described configuration, it is possible to register the LiDAR point cloud with respect to the travel environment point cloud 60 in a short time and with high accuracy.

The information processing apparatus 6 further includes the travel environment point cloud update unit 46 (travel environment point cloud update means) configured to update the travel environment point cloud 60, based on the LiDAR point cloud 51 and the precision registration result (registration result) acquired by registering the LiDAR point cloud 51 with respect to the travel environment point cloud 60. According to the above-described configuration, the travel environment point cloud 60 is reconstructed with high accuracy.

The information processing apparatus 6 further includes the point cloud storage unit 42 (travel environment point cloud storage means) configured to store the travel environment point cloud 60. The point cloud storage unit 42 classifies the travel environment point cloud 60 into a plurality of travel track point clouds 61 and stores the classified point clouds. According to the above-described configuration, when the approximate registration unit 43 performs the approximate registration, it is possible to omit the calculation of extracting any one of the travel track point clouds 61 from the travel environment point cloud 60. However, instead of this, the approximate registration unit 43 may extract the travel track point cloud 61 associated with the LiDAR point cloud 51 from the travel environment point cloud 60 each time when performing the approximate registration.

In addition, the sensing information reception unit 40 is provided in the information processing apparatus 6 arranged in the railway track environment 1. The information processing apparatus 6 acquires, from the train 5 when the train 5 reaches the information processing apparatus 6, the LiDAR point cloud 51 of the section in which the train 5 has traveled, and provides the train 5 with the operation assistance information (assistance information) based on the travel environment point cloud 60 updated by the travel environment point cloud update unit 46. According to the above-described configuration, it is possible to stably transmit and receive large-scale data such as the LiDAR point cloud 51 and the operation assistance information to and from the traveling train 5.

Further, the operation assistance information transmitted by the operation assistance information transmission unit 48 to the train 5 is associated with a section in which the train 5 is to travel. In other words, the operation assistance information transmitted by the operation assistance information transmission unit 48 to the train 5 is narrowed down to the operation assistance information relating to the section in which the train 5 is to travel. According to the above-described configuration, it is possible to suppress the amount of data communication between the train 5 and the information processing apparatus 6 as compared with a case where the operation assistance information relating to the entire railway track environment 1 is provided to the train 5.

In the above-described example embodiment, the train 5 traveling along the railway track 2 is exemplified as one example of the moving body. However, the present invention is not limited thereto, and the moving body may be an automobile traveling on a road. In such a case, the lane of the road corresponds to the travel track.

Next, a hardware configuration of the information processing apparatus 6 is described. In the information processing apparatus 6, the sensing information reception unit 40, the point cloud storage unit 42, the approximate registration unit 43, the precision registration unit 44, the travel environment point cloud update unit 46, the travel assistance information generation unit 47, and the travel assistance information transmission unit 48 are implemented by a processing circuit. The sensing information storage unit 41 and the registration result storage unit 45 are implemented by a storage circuit. The processing circuit may be a memory and a processor that execute a program stored in the memory, or may be dedicated hardware.

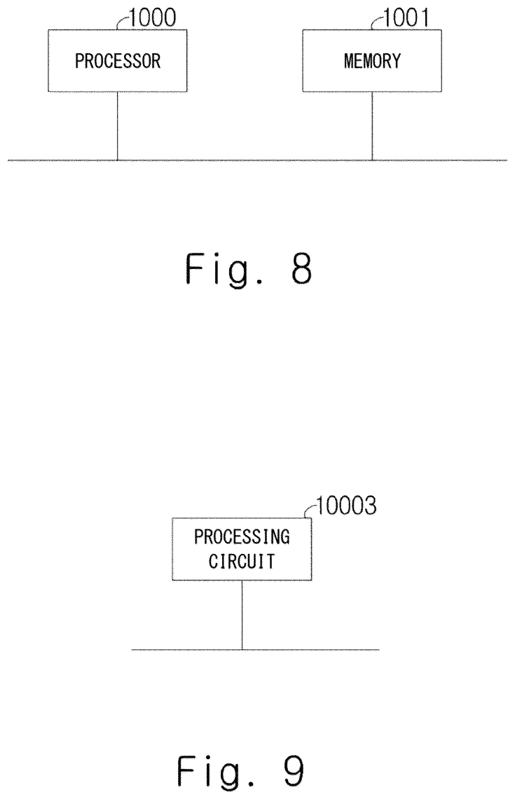

FIG. 8 is a diagram illustrating an example of a case where a processing circuit included in the information processing apparatus 6 is configured by a processor and a memory. In a case where the processing circuit is configured by a processor 1000 and a memory 1001, the functions of the processing circuit of the information processing apparatus 6 are implemented by software, firmware, or a combination of software and firmware. The software or firmware is written as a program and stored in the memory 1001. In the processing circuit, each function is implemented by the processor 1000 reading and executing a program stored in the memory 1001. That is, the processing circuit includes the memory 1001 configured to store a program in which processing of the information processing apparatus 6 is to be executed. These programs can also be said to cause a computer to execute procedures and methods for the information processing apparatus 6.

Herein, the processor 1000 may be a central processing unit (CPU), a processing apparatus, an arithmetic apparatus, a microprocessor, a microcomputer, a digital signal processor (DSP), or the like. The memory 1001 includes, for example, a non-volatile or volatile semiconductor memory such as a random access memory (RAM), a read only memory (ROM), a flash memory, an erasable programmable ROM (EPROM), or an electrically EPROM (EEPROM) (registered trademark), a magnetic disk, a flexible disk, an optical disk, a compact disk, a mini disk, a digital versatile disc (DVD), or the like.

FIG. 9 is a diagram illustrating an example of a case where a processing circuit included in the information processing apparatus 6 is configured by dedicated hardware. In a case where the processing circuit is configured by dedicated hardware, a processing circuit 10003 illustrated in FIG. 9 is, for example, a single circuit, a composite circuit, a programmed processor, a parallel programmed processor, an application specific integrated circuit (ASIC), a field programmable gate array (FPGA), or a combination thereof. Each function of the information processing apparatus 6 may be implemented by the processing circuit 10003 separately for each function, or each function may be implemented collectively by the processing circuit 10003.

Note that, some of the functions of the information processing apparatus 6 may be implemented by dedicated hardware, and some of the functions may be implemented by software or firmware. In such a manner, the processing circuit may implement the above-described functions by dedicated hardware, software, firmware, or a combination thereof.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures may be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

An example advantage according to the above-described configuration is a technique for registering a sensing point cloud with respect to a travel environment point cloud in a short time.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

The whole or part of the example embodiments disclosed above can be described as, but not limited to, the following supplementary notes.

### (Supplementary Note 1)

A point cloud processing system including:
a sensing information acquisition means for acquiring sensing information including a sensing point cloud generated by a sensing means, which is mounted on a moving body traveling on any one of a plurality of travel tracks extending in parallel to one another, for sensing an area ahead in a heading direction of the moving body, and track identification information identifying a travel track on which the moving body travels while performing sensing; and
a first registration means for registering the sensing point cloud with respect to a travel track point cloud associated with the travel track on which the moving body travels while performing sensing, among a travel environment point cloud being a known point cloud of a travel environment including the plurality of travel tracks.

### (Supplementary Note 2)

The point cloud processing system according to supplementary note 1, further including a second registration means for registering the sensing point cloud with respect to the travel environment point cloud by using a registration result acquired by registering the sensing point cloud with respect to the travel track point cloud as an initial condition.

### (Supplementary Note 3)

The point cloud processing system according to supplementary note 2, further including a travel environment point cloud update means for updating the travel environment point cloud, based on the sensing point cloud and a registration result acquired by registering the sensing point cloud with respect to the travel environment point cloud.

### (Supplementary Note 4)

The point cloud processing system according to supplementary note 1, further including a travel environment point cloud storage means for storing the travel environment point cloud, wherein the travel environment point cloud storage means classifies the travel environment point cloud into a plurality of travel track point clouds and stores the classified point clouds.

### (Supplementary Note 5)

The point cloud processing system according to supplementary note 3, wherein
the sensing information acquisition means is provided in an information processing apparatus arranged in the travel environment, and
the information processing apparatus is configured to acquire, from the moving body when the moving body reaches the information processing apparatus, the sensing point cloud of a section in which the moving body has traveled, and provides the moving body with assistance information based on the travel environment point cloud updated by the travel environment point cloud update means.

### (Supplementary Note 6)

The point cloud processing system according to supplementary note 5, wherein the assistance information is associated with a section in which the moving body is to travel.

### (Supplementary Note 7)

The point cloud processing system according to supplementary note 1, wherein the moving body is an automobile or a train.

### (Supplementary Note 8)

A point cloud processing apparatus including:
a sensing information acquisition means for acquiring sensing information including a sensing point cloud generated by a sensing means, which is mounted on a moving body traveling on any one of a plurality of travel tracks extending in parallel to one another, for sensing an area ahead in a heading direction of the moving body, and track identification information identifying a travel track on which the moving body travels while performing sensing; and
a first registration means for registering the sensing point cloud with respect to a travel track point cloud associated with the travel track on which the moving body travels while performing sensing, among a travel environment point cloud being a known point cloud of a travel environment including the plurality of travel tracks.

### (Supplementary Note 9)

A point cloud processing method including:
acquiring sensing information including a sensing point cloud generated by a sensing means, which is mounted on a moving body traveling on any one of a plurality of travel tracks extending in parallel to one another, for sensing an area ahead in a heading direction of the moving body, and track identification information identifying a travel track on which the moving body travels while performing sensing; and
registering the sensing point cloud with respect to a travel track point cloud associated with the travel track on which the moving body travels while performing sensing, among a travel environment point cloud being a known point cloud of a travel environment including the plurality of travel tracks.

### (Supplementary Note 10)

A program for causing a computer to execute the point cloud processing method according to supplementary note 9.

What is claimed is:

1. A point cloud processing system comprising:
at least one memory storing computer-executable instructions; and
at least one processor configured to access the at least one memory and execute the computer-executable instructions to:
acquire sensing information including a sensing point cloud generated by sensing means, which is mounted on a moving body traveling on any one of a plurality of travel tracks extending in parallel to one another, for sensing an area ahead in a heading direction of the moving body, and track identification information identifying a travel track on which the moving body travels while performing sensing; and
register the sensing point cloud with respect to a travel track point cloud associated with the travel track on which the moving body travels while performing sensing, among a travel environment point cloud being a known point cloud of a travel environment including the plurality of travel tracks.

2. The point cloud processing system according to claim 1, wherein the at least one processor is further configured to execute the instructions to register the sensing point cloud with respect to the travel environment point cloud by using a registration result acquired by registering the sensing point cloud with respect to the travel track point cloud as an initial condition.

3. The point cloud processing system according to claim 2, wherein the at least one processor is further configured to execute the instructions to update the travel environment point cloud, based on the sensing point cloud and a registration result acquired by registering the sensing point cloud with respect to the travel environment point cloud.

4. The point cloud processing system according to claim 1, wherein the at least one processor is further configured to execute the instructions to classify the travel environment point cloud into a plurality of travel track point clouds and store the classified point clouds.

5. The point cloud processing system according to claim 3, the point cloud processing system being provided in an information processing apparatus arranged in the travel environment,
wherein the at least one processor is further configured to execute the instructions to cause the information processing apparatus to acquire, from the moving body when the moving body reaches the information processing apparatus, the sensing point cloud of a section in which the moving body has traveled, and provide the moving body with assistance information based on the travel environment point cloud updated by the travel environment point cloud update means.

6. The point cloud processing system according to claim 5, wherein the assistance information is associated with a section in which the moving body is to travel.

7. The point cloud processing system according to claim 1, wherein the moving body is an automobile or a train.

8. A point cloud processing apparatus comprising:
at least one memory storing computer-executable instructions; and
at least one processor configured to access the at least one memory and execute the computer-executable instructions to:
acquire sensing information including a sensing point cloud generated by sensing means, which is mounted on a moving body traveling on any one of a plurality of travel tracks extending in parallel to one another, for sensing an area ahead in a heading direction of the moving body, and track identification information identifying a travel track on which the moving body travels while performing sensing; and
register the sensing point cloud with respect to a travel track point cloud associated with the travel track on which the moving body travels while performing sensing, among a travel environment point cloud being a known point cloud of a travel environment including the plurality of travel tracks.

9. A computer-implemented point cloud processing method being performed by at least one processor executing stored instructions to perform steps comprising:
acquiring sensing information including a sensing point cloud generated by sensing means, which is mounted on a moving body traveling on any one of a plurality of travel tracks extending in parallel to one another, for sensing an area ahead in a heading direction of the moving body, and track identification information identifying a travel track on which the moving body travels while performing sensing; and
registering the sensing point cloud with respect to a travel track point cloud associated with the travel track on which the moving body travels while performing sensing, among a travel environment point cloud being a known point cloud of a travel environment including the plurality of travel tracks.

10. A non-transitory computer-readable storage medium storing a program for causing a computer to execute processing according to claim 9.
